(19) United States
(12) Patent Application Publication
(10) Pub. No.: US 2010/0313960 A1
(43) Pub. Date: Dec. 16, 2010

(54) High Performance Transducer

(76) Inventors: Andy R. Askew, Pfafftown, NC (US); Gregory S. Lyon, Mamaroneck, NY (US); Stanley Marion Przybylowicz, Winston-Salem, NC (US)

Correspondence Address: KILPATRICK STOCKTON LLP, 1001 WEST FOURTH STREET, WINSTON-SALEM, NC, 27101, US

(21) Appl. No.: 12/678,229

(22) PCT Filed: Mar. 27, 2008
(86) PCT No.: PCT/US08/58440

§ 371 Date: Sep. 2, 2010

Related U.S. Application Data
(60) Provisional application No. 60/921,195, filed on Mar. 30, 2007.

(51) Int. Cl. F16K 31/02

(52) U.S. Cl. 137/1; 137/487.5

(57) ABSTRACT

An electro-pneumatic transducer for controlling gas pressure is disclosed. The transducer includes a nozzle body and a valve housing interconnected therebetween by a nozzle and a solenoid assembly including a magnetized valve assembly and a solenoid having a top portion and a bottom portion, which when energized generate a magnetic field having a predetermined polarity in response to which the magnetized valve assembly is actuated to control gas flow through the nozzle. The transducer also includes a control circuit adapted to receive an input signal. The control circuit is configured to energize the solenoid in response to the input signal to generate the magnetic field thereabout to actuate the valve assembly. The transducer further includes a capacitor coupled to the control circuit, wherein upon loss of the input signal, the control circuit signals the capacitor to provide an electrical signal to the solenoid to actuate the valve assembly.

### CROSS REFERENCE TO RELATED APPLICATION

The present application claims a benefit of priority to U.S. Provisional Application Ser. No. 60/921,195 filed on Mar. 30, 2007 entitled “High Performance Transducer,” the entire contents of which is being incorporated by reference herein.

### BACKGROUND

1. Field

The present disclosure relates generally to pressure transducers, more specifically to electro-pneumatic transducers adapted to maintain operating pressure in the event of signal loss.

2. Description of the Related Art

Current-to-pressure (“I/P”) electro-pneumatic transducers that utilize voice coils are well known in the art. These transducers control the pressure output in response to a predetermined electronic or electric control signal. Transducers are often exposed to extreme weather, such as excessive moisture, temperatures and winds, which may interfere with the operation of the transducer. In particular, dust and moisture may enter into the transducer and disrupt the signals, thereby interrupting controlled pressure output of the transducers.

In the event of signal loss, the output pressure is affected accordingly, such as the pressure simply drops to the equilibrium pressure created by the minimum biasing force of the suspension spring associated with the voice coil of the transducer. In some instances, it is desirable to maintain the pressure output (e.g., higher pressure or zero output pressure) even upon loss of signal. The ability to maintain pressure allows the process, in which the transducer is disconnected, to recover quicker and safer from the signal loss. Similarly, the ability to maintain zero output pressure in the event of signal loss is also beneficial for safety reasons. Therefore there is a need for a transducer which is adapted to maintain output pressure despite signal loss.

### SUMMARY

The present disclosure provides for a transducer coupled to a booster chamber, the transducer having a vent nozzle and a voice coil mounted on a suspension spring with a permanent magnet that controls the pressure within the booster chamber. The suspension spring acts with respect to the nozzle to vent gas. The booster chamber also includes a diaphragm pressure transformer, which controls the primary output pressure. As the current supplied to the coil is increased, the pressure within the booster chamber increases accordingly.

The transducer also includes a control circuit coupled to a solenoid valve assembly. The circuit senses the control signal and responds accordingly to effectively maintain the booster chamber pressure in the event of a signal loss. The circuit provides for a so-called “lock in last position” functionality to the transducer allowing the transducer to lock the last pressure output in which the transducer was operating immediately prior to loss of a control signal. Further, the transducer includes a specialized sealing and vent assembly which allow for deployment of the to transducer in harsh environments.

According to one aspect of the present disclosure, an electro-pneumatic transducer for controlling gas pressure is disclosed. The transducer includes a nozzle body and a valve housing interconnected therebetween by a nozzle and a solenoid assembly including a magnetized valve assembly and a solenoid having a top portion and a bottom portion, which when energized generate a magnetic field having a predetermined polarity in response to which the magnetized valve assembly is actuated to control gas flow through the nozzle. The transducer also includes a control circuit adapted to receive an input signal. The control circuit is configured to energize the solenoid in response to the input signal to generate the magnetic field thereabout to actuate the valve assembly. The transducer further includes a capacitor coupled to the control circuit, wherein upon loss of the input signal, the control circuit signals the capacitor to provide an electrical signal to the solenoid to actuate the valve assembly.

A method for controlling for an electro-pneumatic transducer having a nozzle body and a valve housing interconnected therebetween by a nozzle is also contemplated by the present disclosure. The method includes the steps of providing an electro-pneumatic transducer. The transducer includes a solenoid assembly having a magnetized valve assembly and a solenoid having a top portion and a bottom portion, which is energized in response to an input signal to generate a magnetic field having a predetermined polarity. The magnetized valve assembly is actuated in response to the magnetic field to control gas flow through the nozzle. The method also includes the steps of determining whether the input signal deviates from a predetermined operational level to detect a drop in the input signal and signaling a capacitor coupled to the solenoid to provide an electrical signal therefrom to the solenoid to actuate the valve assembly in response to the drop in the input signal.

According to another aspect of the present disclosure, an electro-pneumatic transducer for controlling gas flow is disclosed. The transducer includes a nozzle body and a valve housing interconnected therebetween by a nozzle and a solenoid assembly including a magnetized valve assembly and a solenoid. The solenoid includes a housing and a central bore defined therethrough, the solenoid further includes a top portion and a bottom portion, which when energized generate a magnetic field having a predetermined polarity. The magnetized valve assembly includes a plunger assembly having a shaft adapted to slide through the central bore, a magnetized portion disposed on a top portion of the shaft, a flexible member disposed on the magnetized portion and a coil spring disposed about the shaft adapted to bias the plunger assembly, the magnetized valve assembly is adapted to actuate to control gas flow through the nozzle in response to the magnetic field. The transducer also includes a control circuit adapted to receive an input signal. The transducer further includes a capacitor coupled to the control circuit; the control circuit is configured to charge the capacitor in response to the input signal. Upon reaching a predetermined charge, the control circuit signals the capacitor to energize the solenoid to actuate the valve assembly. The transducer further includes a capacitor coupled to the control circuit, wherein upon loss of the input signal, the control circuit signals the capacitor to provide an electrical signal to the solenoid to actuate the valve assembly.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is an isometric view of an electro-pneumatic transducer according to the present disclosure;

FIG. 2 is a cross-sectional view of the electro-pneumatic transducer of FIG. 1 according to the present disclosure;

FIG. 3 is an isometric view of valve and nozzle assemblies of the electro-pneumatic transducer of FIG. 1 according to the present disclosure;

FIG. 4 is an isometric view of the electro-pneumatic transducer of FIG. 1 with parts disassembled according to the present disclosure;

FIG. 5 is an isometric view of the electro-pneumatic transducer of FIG. 1 with parts disassembled according to the present disclosure;

FIG. 6 is an isometric view of a valve housing of the electro-pneumatic transducer of FIG. 1 with parts disassembled according to the present disclosure;

FIG. 7 is an isometric view of a solenoid assembly of the electro-pneumatic transducer of FIG. 1 with parts disassembled according to the present disclosure;

FIGS. 8A-B are cross-sectional views of the solenoid assembly of the electro-pneumatic transducer of FIG. 1 according to the present disclosure;

FIG. 9 is an isometric view of the solenoid assembly of the electro-pneumatic transducer of FIG. 1 with parts disassembled according to the present disclosure;

FIG. 10 is cross-sectional view of a plunger assembly of the solenoid assembly of FIG. 9 according to the present disclosure;

FIGS. 11A-B are cross-sectional views of the plunger assembly of FIG. 10 according to the present disclosure; and

FIG. 12 is a flow chart illustrating a method for controlling the electro-mechanical transducer of FIG. 1 according to the present disclosure.

### DETAILED DESCRIPTION

Particular embodiments of the present disclosure will be described herein below with reference to the accompanying drawings. In the following description, well-known functions or constructions are not described in detail to avoid obscuring the present disclosure in unnecessary detail.

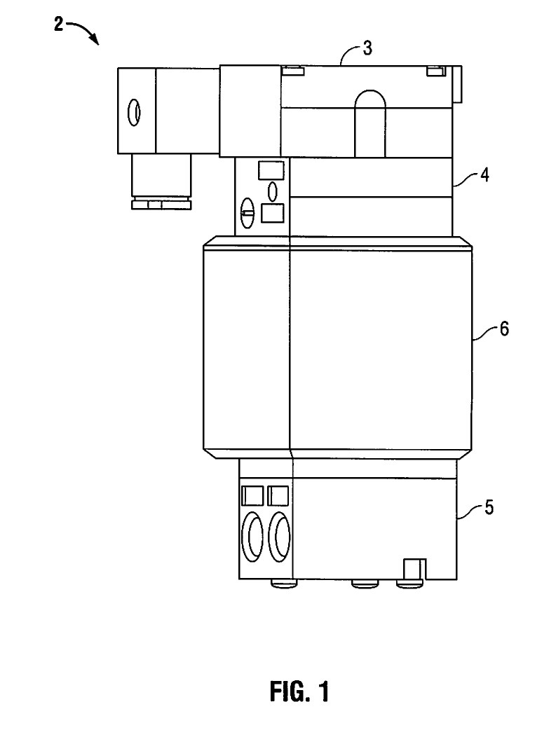

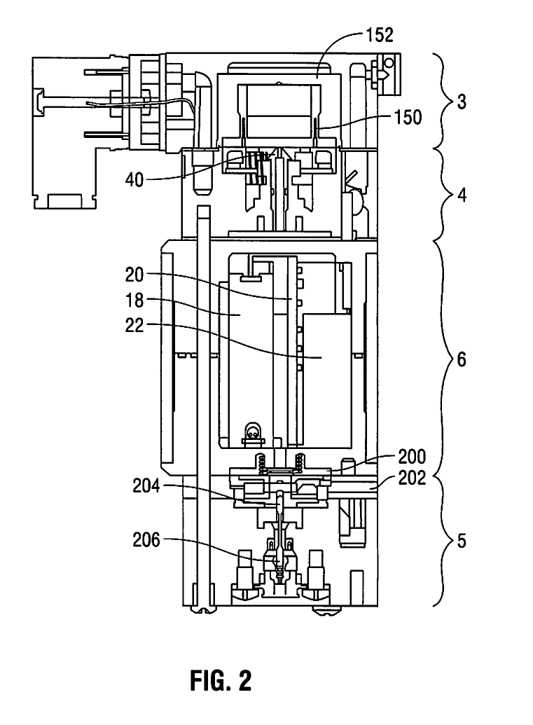

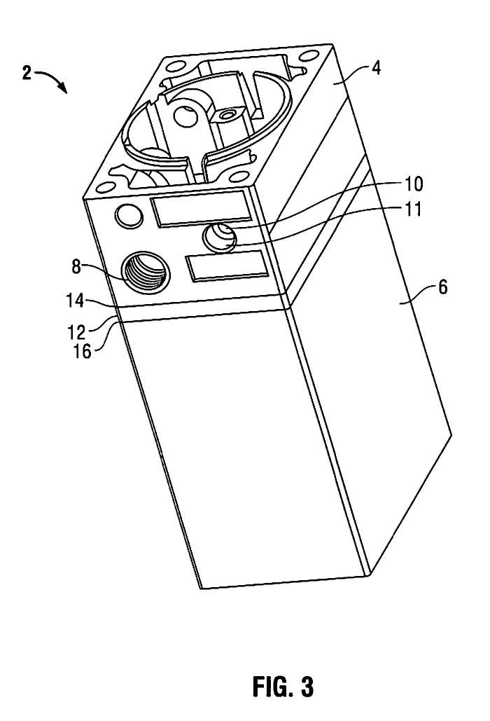

FIGS. 1-4 show an electro-pneumatic transducer 2 having a nozzle body 4, which is disposed on top of a valve housing 6. The transducer 2 also includes an electro-pneumatic converter section 3 coupled to the nozzle body 4 and a booster chamber 5 coupled to the valve housing 6. The converter section 3 includes a voice coil 150 having a magnet assembly 152. The voice coil 150 may be any type of magnetically controlled diaphragm which acts as a primary control of the flow of gas into the transducer 2.

The nozzle body 4 includes at least one inlet port 8 for supplying a gas (e.g., at reduced pressure) from the voice coil 150 and a vent port 10 for venting the gas (e.g., at higher pressure). Since the vent port 10 allows the gas to escape the body of the transducer 2, the vent port 10 includes an effective seal which permits selective venting of the gas.

The transducer 2 is coupled to the booster chamber 5 through the valve housing 6. The booster chamber 5 includes an amplifying diaphragm 200 coupled to a booster vent 202, an exhaust valve 204 and a supply valve 206. The amplifying diaphragm 200 leverages the pressure in the booster chamber 5 to modify the pressure of the supplied gas via the supply valve to the desired pressure based on the control signal and provides enhanced flow capacity.

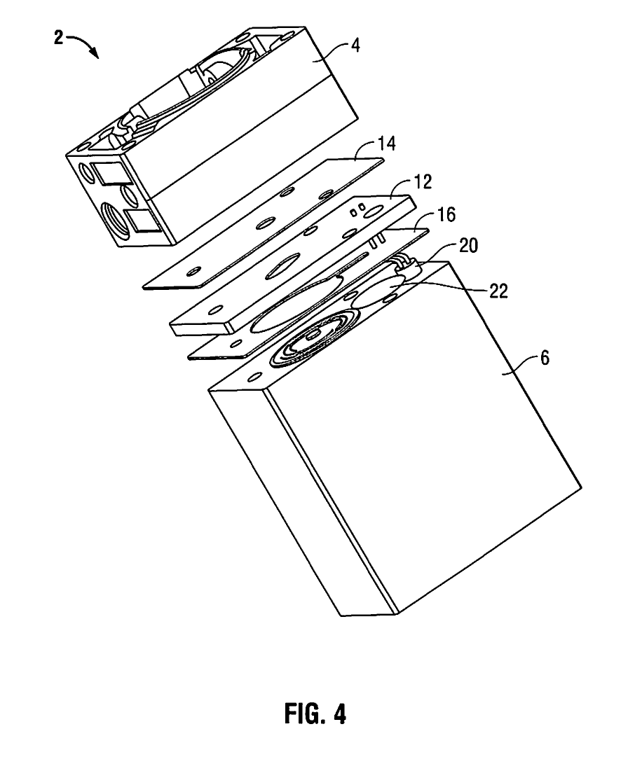

The transducer 2 also includes a solenoid cap plate 12 disposed between gaskets 14 and 16, all of which are disposed in between the nozzle body 4 and the valve housing 6 as shown in FIG. 4. The supplied gas flows through the nozzle body 4, the solenoid cap plate 12 and the valve housing 6 to the booster chamber 5. Accordingly, the solenoid cap plate 12 and the valve housing 6 serve as a conduit for the supplied gas from the nozzle body 4 to the booster chamber 5.

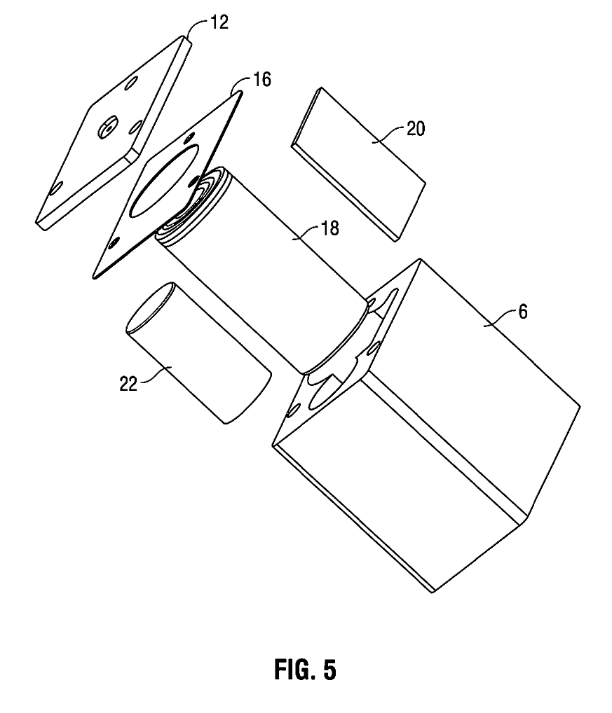

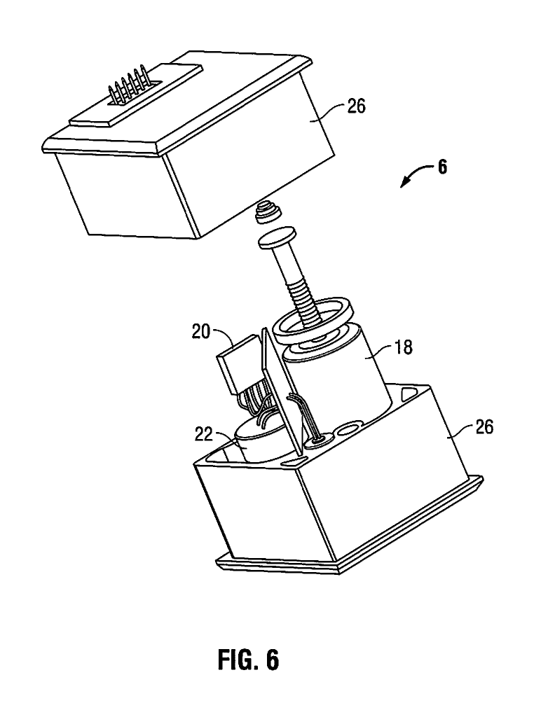

FIG. 5 shows one embodiment of the valve housing 6 including a solenoid assembly 18, a control circuit 20 and a capacitor 22. The valve housing 6 may have a substantially rectangular shape with a cavity 24 adapted to fully enclose the solenoid assembly 18, the control circuit 20 and the capacitor 22 therein. In another embodiment shown in FIG. 6, the valve housing 6 may include an upper valve housing 26 and a lower valve housing 28. The lower valve housing 28 includes a lower cavity (not explicitly shown) for at least partially enclosing the solenoid assembly 18, the control circuit 20 and the capacitor 22. The upper valve housing 28 also includes an upper cavity (not explicitly shown) for enclosing any portions of the solenoid assembly 18, the control circuit 20 and the capacitor 22 which extend from the lower valve housing 28.

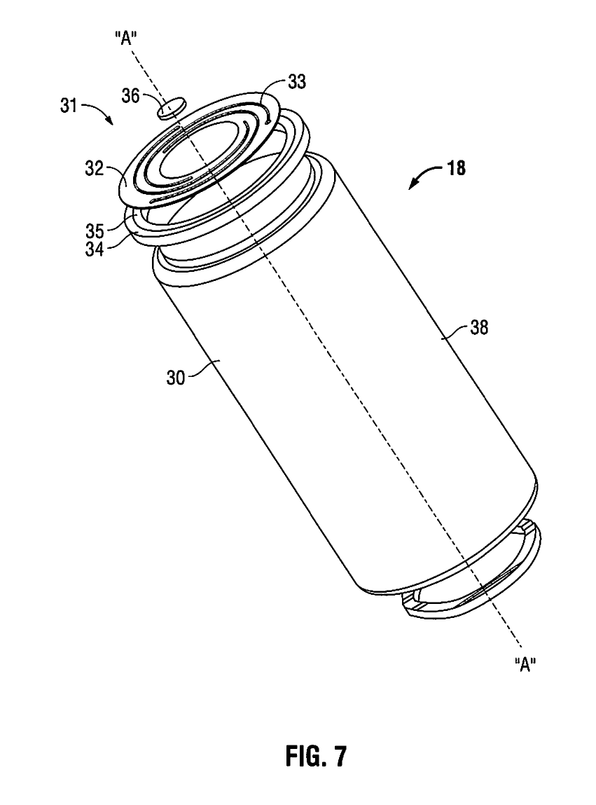

FIG. 7 illustrates the solenoid assembly 18 including a solenoid 30 and a magnetized valve assembly 31 which includes a magnetized elastic member 32 a flapper seal 36 disposed thereon. The solenoid 30 is a two-way pulse activated solenoid, which includes a housing 38 enclosing a coil (not explicitly shown). When the coil is energized either by a positive or negative pulses (e.g., two-way activation), the coil generates a magnetic field in one of the two directions—with the top portion of the solenoid 30 being either north or south and the bottom portion being of opposite polarity. The housing 38 is also constructed from a magnetized metal (e.g., steel). The valve assembly 31 also includes a spring holder 34 disposed on top of the solenoid 30. The spring holder 34 includes a depression 35 adapted to fit around the outer edge of the elastic member 32.

In FIG. 7, the elastic member 32 is shown as a spring disc. In embodiments, the elastic member 32 may be a cantilever or a coil spring constructed from magnetizable elastic materials, such as metals. The elastic member 32 is permanently magnetized or remanenced and may include one or more arcuately shaped slits 33 cut therethrough, which impart elasticity to the elastic member 32. The slits 33 are disposed around the periphery of the elastic member 32 allowing the center of the elastic member 32 to move along longitudinal axis A-A relative to the outer portion thereof. The spring holder 34 also separates the elastic member 32 from the top portion of the solenoid 30, allowing the elastic member 32 to move axially in the space therebetween. The elastic member 32 may be formed from any type of magnetizable metal, such as tempered steel, such that the top portion of the elastic member 32 is one polarity (e.g., north) and the bottom portion is of the opposite polarity (e.g., south).

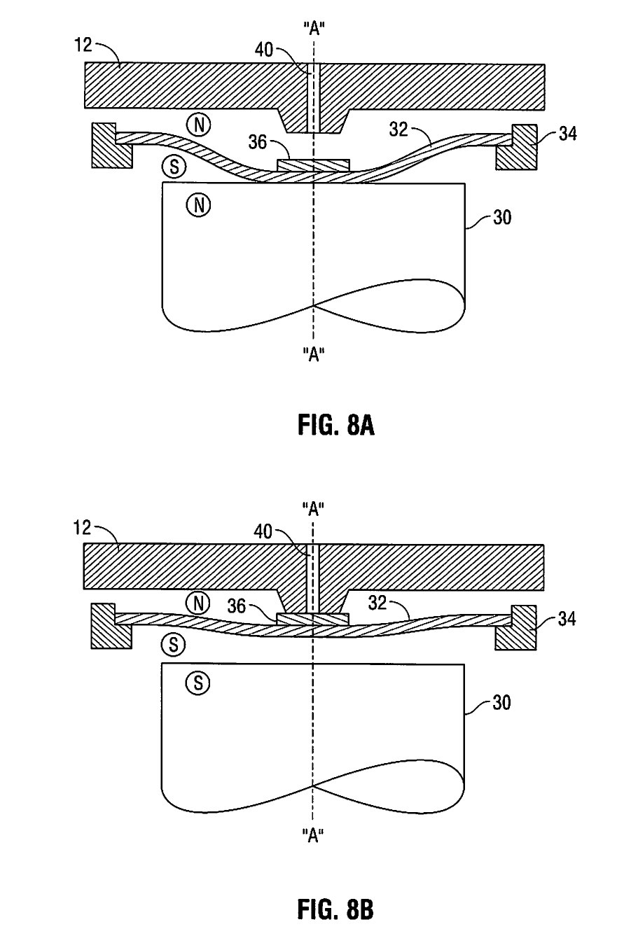

FIGS. 8A-B illustrate the operation of the solenoid assembly 18. In particular, FIG. 8A shows a cross-sectional view of the solenoid assembly 18 with the valve assembly 31 in an open configuration and FIG. 8B shows the valve assembly 31 in a closed configuration. The valve assembly 31 operates by opening and closing a nozzle 40, which is disposed in the solenoid cap plate 12 (e.g., machined therein). In another embodiment shown in FIG. 6, the nozzle 40 may be disposed in the upper valve housing 26. The nozzle 40 allows for the supplied gas to flow from the nozzle body 4 through the solenoid cap plate 12 and into the valve housing 6 to the booster chamber 5.

The valve assembly 31 also includes a flapper seal 36 (FIG. 7), which is affixed to the elastic member 32, such that the flapper seal 36 moves with the elastic member 32. The flapper seal 36 is opened or closed against the nozzle 40 to either allow or block the flow of the supplied gas. The opening and closing of the valve assembly 31 is controlled by changing the polarity of magnetic pulse created by the solenoid 30. The control circuit 20 controls the polarity of the solenoid 30 by directing the polarity of the current flow therethrough. When the solenoid 30 is powered by a first electric signal (e.g., a positive pulse), the top portion of the solenoid 30 temporarily assumes one polarity (e.g., north) and the bottom portion assumes the opposite polarity (e.g., south). When the control circuit 21 reverses the current flow by supplying a second electric signal (e.g., a negative pulse), the polarity of the solenoid 30 is temporarily reversed accordingly.

FIG. 8A depicts the valve assembly 31 in the open configuration, which occurs when the solenoid 30 is powered by the first electrical signal (e.g., positive pulse). In this configuration, the solenoid 30 temporarily assumes a magnetic field in which the top portion of the solenoid 30 is of the opposite polarity than the bottom portion of the elastic member 32. As a result, the elastic member 32 is attracted toward the top portion of the solenoid 30 thereby moving the flapper seal 36 from the nozzle 40 allowing for flow of the supplied gas. The valve assembly 31 remains open until the polarity of the solenoid 30 is reversed. More specifically, the elastic member 32 remains attached to the metallic housing 38 due to permanent magnetization or remanence thereof. The open configuration may be maintained as long as the transducer 2 is powered and receives an input signal.

FIG. 8B depicts the valve assembly 31 in the closed configuration, which occurs when the solenoid 30 is powered by the second electrical signal (e.g., negative pulse). In this configuration, the polarity of the solenoid 30 is temporarily reversed and the top portion of the solenoid 30 is of the same polarity as the bottom portion of the elastic member 32. As a result, the elastic member 32 is pushed upwards and contacts the nozzle 40 with the flapper seal 36 thereby blocking the flow of supplied gas. After the pulse has ceased and the magnetic field has dissipated, the spring force of elastic member 32 maintains the closed position of the flapper seal 36 against the nozzle 40 until the polarity of the solenoid 30 is reversed again.

With reference to FIG. 5, the control circuit 20 is coupled in series with a primary conversion circuit (not explicitly shown). The control circuit 20 is also coupled to the capacitor 22, which is recharged continually whenever the input signal is active. The control circuit 20 receives an electrical input signal and transmits the input signal to the conversion circuit, which may be a constant current driver circuit. The conversion circuit converts the input signals into an electrical signal for controlling the voice coil 150. More specifically, the conversion circuit supplies the voice coil 150 with a current that is proportional to the value of the current of the input signal, which is adjusted by an external potentiometer.

The control circuit 20 also senses when the input signal is outside a predetermined operational level. In particular, the control circuit 20 senses when the input signal drops below the minimum predetermined operational level. The operational level may be a predetermined range (e.g., from about 4 mA to about 20 mA) and the signal deviation may be about 20% (e.g., 3.6 mA or 24 mA) or less from the minimum value of the predetermined range.

When a drop in the input signal below a predetermined threshold is detected, the circuit 20 signals the capacitor 22 to discharge and provide the second electrical signal (e.g., negative pulse) to the solenoid 30. The second electrical signal causes the solenoid 30 to temporarily assume a magnetic field in which the top portion of the solenoid 30 is of the same polarity as the bottom portion of the elastic member 32 thereby closing the valve assembly 31 as discussed above with respect to FIG. 8B. The spring force of elastic member 32 maintains the closed position of the flapper seal 36 against the nozzle 40 until the polarity of the solenoid 30 is reversed again.

When the input signal is recovered, the circuit 20 begins to recharge the capacitor 22. Once the capacitor 22 is sufficiently charged, the circuit 20 then transmits the first electrical signal (e.g., positive pulse) to the solenoid 30. The circuit 20 signals the capacitor 22 to discharge and provide the first electrical signal (e.g., positive pulse) to the solenoid 30. The first electrical signal causes the solenoid 30 to temporarily assume a magnetic field in which the top portion of the solenoid 30 is of the opposite polarity as the bottom portion of the elastic member 32 thereby opening the valve assembly 31, as discussed above with respect to FIG. 8A. In another embodiment, the capacitor 22 may be used to provide the second electrical signal (e.g., negative pulse) to the solenoid 30 to close the valve assembly 31, if the signal loss occurs while the valve assembly 31 is in the open configuration.

In conventional electro-mechanical transducers, upon a signal loss, the valve assembly would not be operated since the signal loss prevents any control of the components of the transducer. The transducer 2 according to the present disclosure prevents a total loss of control over the components (e.g., valve assembly 31) by providing the capacitor 22 for opening the valve assembly 31 and allowing the elastic member 32 to remain in either open or closed position upon occurrence of signal loss.

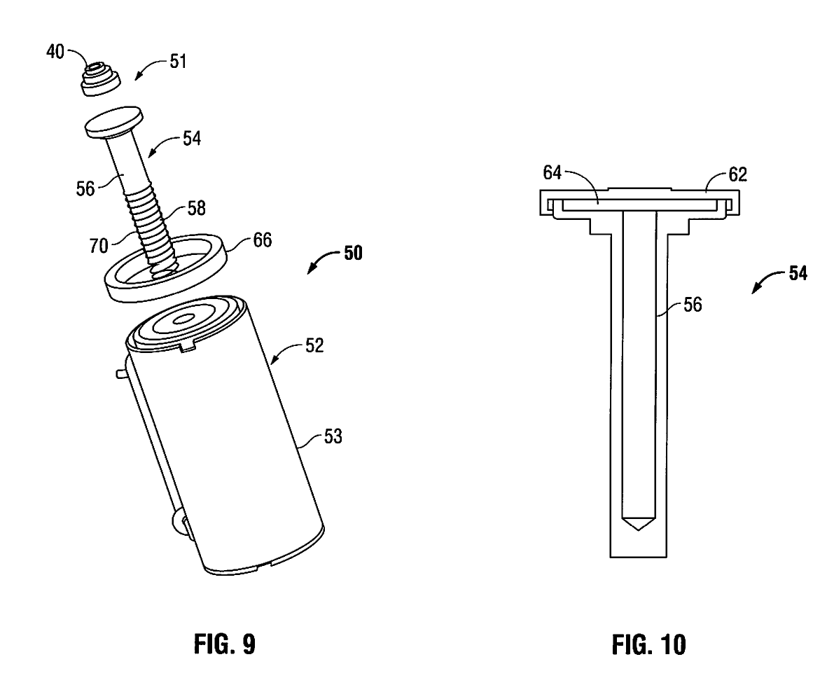

FIGS. 9, 10 and 11A and B illustrate another embodiment of a solenoid assembly 50 including a solenoid 52 and a magnetized valve assembly 51 which includes a plunger assembly 54. The solenoid 52 includes a housing 53 enclosing a coil (not explicitly shown) which when energized by electrical current generates a magnetic field. The housing 53 is constructed from a magnetized metal (e.g., steel).

As shown in more detail in FIG. 10, the plunger assembly 54 includes a shaft 56 having a coil spring 58 disposed thereabout. The plunger assembly 54 also includes a magnetized portion 60 disposed at the top end of the shaft 56. The magnetized portion 60 may be formed from any type of magnetizable metal, such as tempered steel or may be a ferrous magnet, such that the top portion of the magnetized portion 60 is one polarity (e.g., north) and the bottom portion is of the opposite polarity (e.g., south). The plunger assembly 54 also includes a flexible member 62 (e.g., an elastomer cover) having a seal pad 64.

The plunger assembly 54 is disposed within a central bore 68 of the solenoid 50. The plunger assembly 54 includes a coil spring 70, which is also disposed within the central bore 68 and biases the plunger assembly 54 in the upward direction, toward the nozzle 40, thereby pushing the flexible member 62 and the seal pad 65 to impinge upon the nozzle 40. The shaft 56 is adapted slideably fit within the bore 68.

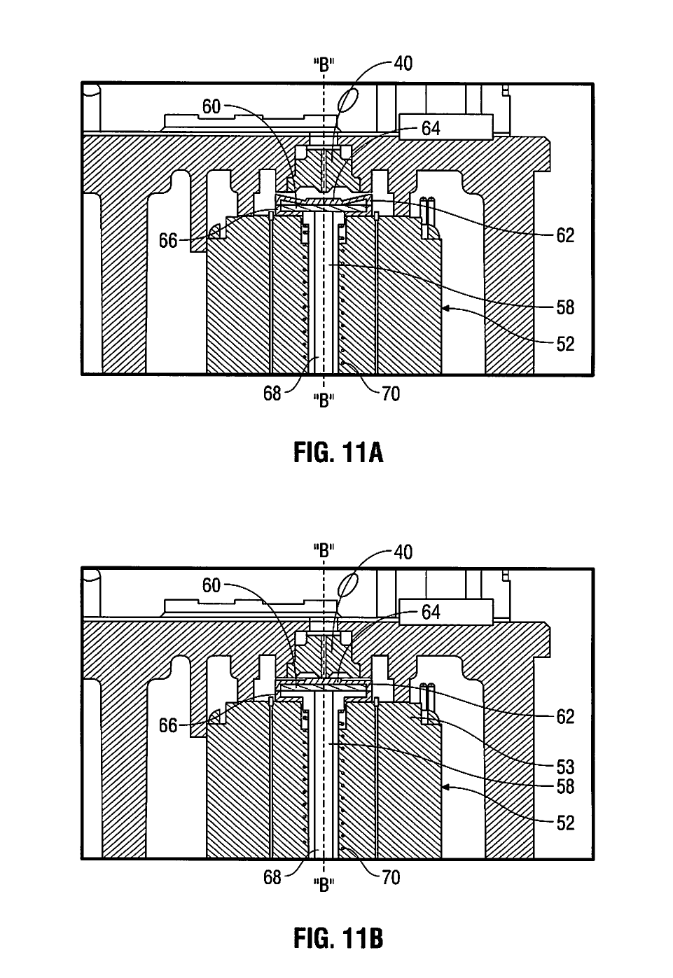

With reference to FIGS. 9 and 11A and B, the solenoid assembly 50 also includes a solenoid spacer 66. The solenoid spacer 66 stages the top end of the plunger assembly 54 a predetermined distance from the nozzle 40. The flexible member 62 is attached to and moves with the top end of the plunger assembly 54. More specifically, the flexible member 62 may include a flanged circumference which folds around under the flange of the top end of the plunger assembly 54 thereby fixing the flexible member 62 thereto. This allows the seal pad 64 to move along longitudinal axis B-B to effect a two-state, open-closed valve as it impinges upon and moves away from the nozzle 40.

FIG. 11A depicts the valve assembly 51 in the open configuration, which occurs when the solenoid 52 is powered by the first electrical signal (e.g., positive pulse). In this configuration, the solenoid 52 temporarily assumes a magnetic field in which the top portion of the solenoid 52 is of the opposite polarity than the bottom portion of the magnetized portion 60. As a result, the magnetized portion 60 is attracted toward the top portion of the solenoid 52 thereby drawing the magnetized portion along with the seal pad away from the nozzle. This action opens the nozzle 40 allowing for continuous flow of gas. The valve assembly 51 remains open until the polarity of the solenoid 52 is reversed. More specifically, the magnetized portion 60 remains attached to the metallic housing 53 due to permanent magnetization or remanence thereof. The open configuration may be maintained as long as the transducer 2 is powered and receives an input signal.

FIG. 11B depicts the valve assembly 51 in the closed configuration, which occurs when the solenoid 52 is powered by the second electrical signal (e.g., negative pulse). In this configuration, the polarity of the solenoid 52 temporarily assumes a magnetic field in which the top portion of the solenoid 52 is of the same polarity as the bottom of magnetized portion 60. As a result, the plunger assembly 54, namely the shaft 56, the magnetized portion 60 and the elastomer, are pushed upwards against the nozzle 40. This force overcomes the magnetic attraction between the housing 53 and the magnetized portion 60, and impinging the seal pad 64 upon the nozzle 40 thereby blocking the flow of supplied gas. The spring force of coil spring 70 maintains the closed position of the seal pad 64 against the nozzle 40 until the polarity of the solenoid 52 is reversed again.

During the loss of input signal, the solenoid 52 receives the second electrical signal (e.g., negative pulse), thereby closing the valve assembly 51 as discussed above in FIG. 11B. Simultaneously, the circuit 20 continues to supply the last stable current signal to the voice coil 150 for a short duration, drawing power from the capacitor 22 instead of the input signal. This allows the circuit 20 to maintain the booster control pressure, while the valve assembly 51 closes. This eliminates a drop in pressure which would otherwise occur during the plunger assembly 54 transitioning from an open to closed configuration.

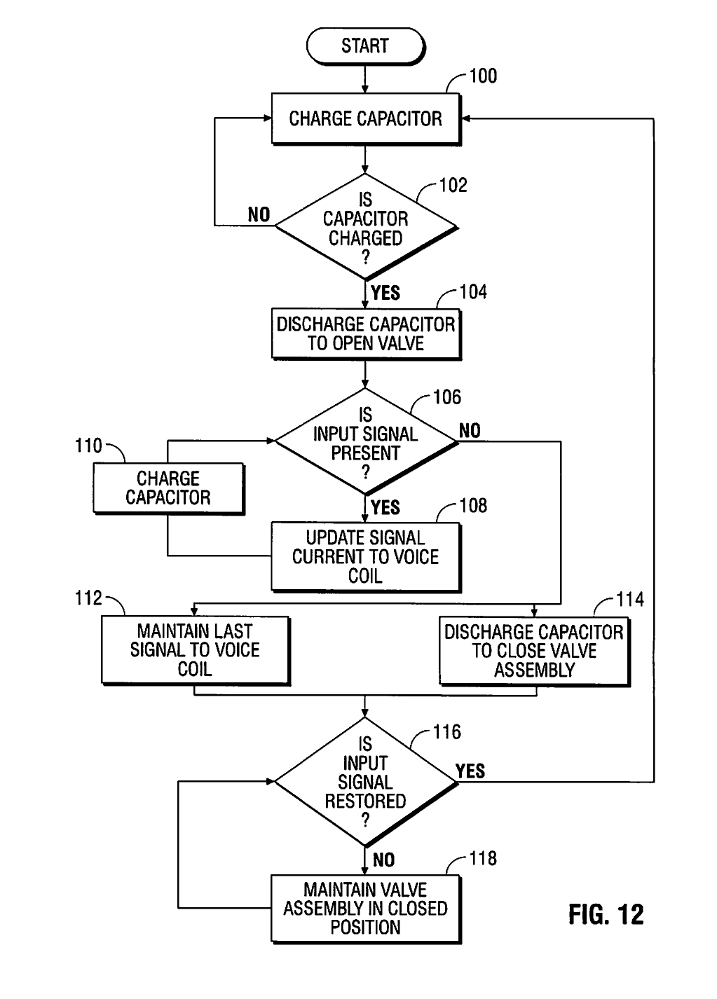

FIG. 12 shows a flow chart of a method for operating the transducer 2 in the event of a signal loss according to the present disclosure. The method is described with respect to the solenoid assembly 18 and it is understood that the method may be applied to the solenoid assembly 50.

In step 100, during initial operation, when the input signal is within the operational range, the capacitor 22 is charged to a predetermined level. In step 102, the control circuit 20 senses when the capacitor has been charged to a predetermined level. In step 104, the circuit 20 signals the capacitor 22 to discharge and provide an electrical signal (e.g., a positive pulse) to the solenoid 30. The first electrical signal (e.g., a positive pulse) causes the solenoid 30 to temporarily assume a magnetic field in which the top portion of the solenoid 30 is opposite polarity of the bottom portion of the elastic member 32 thereby opening the valve assembly 31 as discussed above with respect to FIG. 8A.

In step 106, the circuit 20 monitors the input signal to determine whether the input signal is above the threshold value. If yes, method proceeds to step 108 and the circuit 20 updates the signal current to the voice coil 150 to be proportional to the input signal. In step 110, the control circuit maintains the charge on the capacitor. Method loops back to step 106 and continues to monitor the input signal. If the input signal is below the threshold value, method branches to step 112 to maintain the last signal stored for the voice coil 150. Method simultaneously executes step 114 and the control circuit 20 signals the capacitor to discharge and provide an electrical signal (e.g., a negative pulse) to the solenoid 30. A second electrical signal (e.g., a negative pulse) causes the top portion of the solenoid 30 to be of the same polarity as the bottom portion of the elastic member 32, thereby closing the valve assembly 31 as discussed above with respect to FIG. 8B. In step 116, the control circuit is ready to respond to the restoration of the input signal. If no signal is present, the previous closed configuration of the valve assembly 31 is maintained, due to the biasing force of the elastic member 32 or coil spring 70 under the plunger assembly 54. Upon restoration of the control signal, the method branches back to step 100 to start the process over.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. An electro-pneumatic transducer for controlling gas pressure having a nozzle body and a valve housing interconnected therebetween by a nozzle, the transducer comprising:
a solenoid assembly including a magnetized valve assembly and a solenoid having a top portion and a bottom portion, which when energized generate a magnetic field having a predetermined polarity in response to which the magnetized valve assembly is actuated to control gas flow through the nozzle;
a control circuit adapted to receive an input signal, the control circuit configured to energize the solenoid in response to the input signal to generate the magnetic field thereabout to actuate the valve assembly; and
a capacitor coupled to the control circuit, wherein upon loss of the input signal, the control circuit signals the capacitor to provide an electrical signal to the solenoid to actuate the valve assembly.

2. The electro-pneumatic transducer according to claim 1, wherein the magnetized valve assembly includes a magnetized elastic member having a flapper seal disposed on the magnetized elastic member.

3. The electro-pneumatic transducer according to claim 2, wherein the magnetized elastic member is selected from the group consisting of a spring disc, a cantilever and a coil spring.

4. The electro-pneumatic transducer according to claim 2, wherein the valve assembly is configured to switch between an open configuration in which the magnetized elastic member is of the opposite polarity as the top portion of the solenoid and the magnetized elastic member is pulled away from the nozzle and a closed configuration during which the magnetized elastic member is of same polarity than the top portion of the solenoid and the magnetized elastic member is pushed against the nozzle.

5. The electro-pneumatic transducer according to claim 4, wherein the magnetized valve assembly maintains the closed configuration due to the spring force of the magnetized elastic member and maintains the open configuration due to the permanent magnetization of the magnetized elastic member.

6. The electro-pneumatic transducer according to claim 1, wherein the control circuit is configured to determine whether the input signal deviates from a predetermined operational level by a predetermined signal deviation to detect the drop in the input signal.

7. The electro-pneumatic transducer according to claim 6, wherein the predetermined operational level is from about 4 mA to about 20 mA and the predetermined signal deviation may be about 20%.

8. The electro-pneumatic transducer according to claim 1, wherein the solenoid includes a housing and a central bore defined therethrough and the magnetized valve assembly includes a plunger assembly having a shaft adapted to slide through the central bore, a magnetized portion disposed on a top portion of the shaft, a flexible member disposed on the magnetized portion and a coil spring disposed about the shaft adapted to bias the plunger assembly.

9. The electro-pneumatic transducer according to claim 8, wherein the valve assembly is configured to switch between an open configuration in which the magnetized portion is of the opposite polarity as the top portion of the solenoid and the plunger assembly is pulled away from the nozzle and a closed configuration during which the magnetized portion is of same polarity than the top portion of the solenoid and the plunger assembly is pushed against the nozzle.

10. The electro-pneumatic transducer according to claim 10, wherein the magnetized valve assembly maintains the closed configuration due to the spring force of the coil spring and maintains the open configuration due to the permanent magnetization of the magnetized portion.

11. A method for controlling for an electro-pneumatic transducer having a nozzle body and a valve housing interconnected therebetween by a nozzle, the method comprising the steps of providing an electro-pneumatic transducer, the transducer including a solenoid assembly including a magnetized valve assembly and a solenoid having a top portion and a bottom portion, which is energized in response to an input signal to generate a magnetic field having a predetermined polarity, wherein the magnetized valve assembly is actuated in response to the magnetic field to control gas flow through the nozzle;
determining whether the input signal deviates from a predetermined operational level to detect a drop in the input signal; and
signaling a capacitor coupled to the control circuit to provide an electrical signal therefrom to the solenoid to actuate the valve assembly in response to the drop in the input signal.

12. The method according to claim 11, further comprising the step of:
maintaining the valve assembly in at least one of an open configuration and a closed configuration in response to the drop in the input signal once the valve assembly is actuated.

13. The method according to claim 11, further comprising the step of:
recharging the capacitor once the input signal is restored to the predetermined operational level.
